(19) United States
(12) Patent Application Publication
(10) Pub. No.: US 2019/0345044 A1
(43) Pub. Date: Nov. 14, 2019

(54) DC-POWERED ELECTROCHEMICALLY REACTIVE MEMBRANE

(71) Applicant: BRISEA CAPITAL, LLC, Parsippany, NJ (US)

(72) Inventors: Wen Zhang, Livingston, NJ (US); Yuhong Jiang, Whippany, NJ (US)

(21) Appl. No.: 16/404,925

(22) Filed: May 7, 2019

Related U.S. Application Data
(60) Provisional application No. 62/669,105, filed on May 9, 2018.

(51) Int. Cl. C02F 1/467; C02F 1/461; C02F 1/44; B01D 63/06; B01D 61/18; B01D 65/08

(52) U.S. Cl. CPC C02F 1/4672; C02F 1/46109; C02F 1/44; B01D 63/06; B01D 61/18; C02F 2101/363; C02F 2001/46171; B01D 2313/365; B01D 2313/345; B01D 2311/2684; B01D 2321/22; B01D 65/08

(57) ABSTRACT

An electrochemically reactive membrane filtration system that exhibits antifouling characteristics, high surface reactivity and removal of organic pollutants and microbes in water. Such electrochemically reactive membrane systems can be incorporated as a core part of point-of-use (POU) water treatment and disinfection devices that exhibit performance of water purification at the endpoint of drinking water supply (e.g., tap water or pure water machine) and warrant the drinking water quality.

### CROSS-REFERENCE TO RELATED APPLICATIONS

The present application claims the benefit of U.S. Provisional Patent Application No. 62/669,105, filed May 9, 2019, the content of which is hereby expressly incorporated by reference in its entirety.

### FIELD OF INVENTION

The present disclosure relates to an apparatus and method for filtration of drinking water. More particularly, the present disclosure relates to a drinking water filter having a reactive electrochemical membrane that is powered by direct current.

### BACKGROUND

Micropollution in natural waters such as rivers and groundwater aquifers prevents these potentially potable sources from being used as drinking water. In the United States, for example, many hazardous waste sites are contaminated with trichloroethylene (TCE), a potentially carcinogenic compound. TCE and 2,4,6-trichlorophenol (TCP), a carcinogenic and persistent pollutant, represent the large class of chlorinated organics responsible for the contamination of many potential drinking water sources around the world. Other emerging and environmentally persistent organic micropollutants include polyromantic hydrocarbons (PAHs), organophosphate flame retardants, endocrine disrupting compounds (EDCs), pesticides, herbicides, pharmaceuticals and personal care products (PPCPs). Chloroform is a common contaminant in drinking water, as a byproduct of chlorination processes.

Recent studies have indicated that aeration, chlorine dioxide, dissolved air flotation, coagulation, flocculation, sedimentation, granular filtration, and microfiltration are all ineffective for removing poly- and perfluoroalkyl substances (PFASs) including perfluorooctanoic acid (PFOA) and perfluorooctanesulfonic acid (PFOS). Activated carbon and anion exchange are less effective at removing shorter chain PFASs. The most effective treatment technologies are nanofiltration and reverse osmosis, which are associated with high initial capital investment and operational cost. Ultrafiltration with lower operation pressure than nanofiltration, is usually used for separation of bacteria, which are retained or rejected by the membranes. However, the biofouling of ultrafiltration membrane is a problem for the wide application of this method. And sole ultrafiltration cannot remove emerging contaminants especially those with small molecular sizes. These removal methods do not result in complete degradation and destruction of pollutants, but rather a separation and concentration of PFASs.

Likewise, microbial contamination (e.g., bacteria, viruses, and protozoan) is a global problem for drinking water security. Pathogenic microorganisms such as pervasive SARS, Ebola virus, avian influenzas, and pneumonia cause severe diseases and threaten general public safety and human health. Many waterborne diseases in the US are associated with the opportunistic pathogen Legionella, which may originate from drinking water contamination in distribution systems and premise plumbing. Conventional disinfectants (e.g., chlorine, chlorine dioxide, or ozone) can eliminate a wide spectrum of undesirable microorganisms; however, they also render the rise of more than 600 different disinfection byproducts (DBP) and increase microbial resistance to disinfectant chemicals. Many DBPs (e.g., trichloromethane, bromine-dichloromethane, dibromomethane and tribromomethane) are potentially carcinogenic. Conventional disinfection methods are becoming less efficient due to the evolution of antibiotic-resistant strains or genes. UV irradiation is an effective, safe, and environmentally friendly disinfection method but the lack of persistent antibacterial capacity generally causes high risk of regrowth, particularly in poor sanitation. Due to water quality regulations, water utilities may need to implement alternative treatment technologies to remain in full regulatory compliance.

### SUMMARY

In one embodiment, a method of purifying drinking water or tap water employs an electrochemically reactive membrane system. The application of a direct current (DC) generated reactive species at the membrane surface could oxidize soluble trace level organic compounds such as disinfection byproducts and pathogenic microbes. This method may also reduce membrane fouling and energy consumption for backwash and flux recovery.

Compared to other membrane filtration processes, the electrochemically reactive membrane filtration system has increased efficiency of contaminants degradation and removal, as well as water purification and disinfection. The electrochemically reactive membrane filtration system operates at relatively lower transmembrane pressures (thus requires low pumping pressures to filtrate water) compared to polymeric microfiltration or ultrafiltration of similar pore sizes with low potential of membrane fouling.

The method also preserves Ca²⁺, Mg²⁺, and other trace elements. A traditional reverse osmosis (RO) membrane, on other hand, removes all beneficial elements together with other potentially harmful suspended or soluble particles from the water. Such a process consumes large amounts of power, and results in a permeate having a low pH. Additionally, the RO process removes trace elements that are beneficial to the human health such as Ca²⁺, Mg²⁺. Hence, drinking RO treated water in the long term may cause calcium loss or other potential health risks. On the contrary, an electrochemically reactive membrane does not have such problems.

The disclosed method has a low energy consumption. Both ultrafiltration and microfiltration do not have high demand of water pressure or power.

In one embodiment, the disclosed system employs electrochemical oxidation and membrane filtration. The electrochemically reactive membrane filtration is scalable and battery-operated or DC powered. The electrochemically reactive membrane serves as both filter and anode that permits degradation of pollutants and permeate passage under DC currents. Water permeates through electrochemically reactive membrane filters under a mild hydraulic pressure that may be provided from a peristaltic pump or from the tap water pressure itself. The water treatment performance largely relies on the degradation kinetics of different pollutants in water on the porous electrode filters (e.g., Fe/Pd, Cu/Pd, Ni/Pd, Al/Pd, Carbon/Pd, boron-doped diamond, and TiO₂/Al₂O₃). For example, the membranes may be synthesized from conductive titanium-based materials (e.g., substoichiometric titanium dioxide or Ti₄O₇) and any kinds of membranes with materials displaying high conductivity, or combinations thereof. The sizes of the electrode could vary.

The application of a DC generated reactive species at the electrochemically reactive membrane surface oxidizes soluble organic compounds. There are additional benefits of electrochemically reactive membranes such as reduced membrane fouling, reduction of organic (toxic) compounds in permeate and energy consumption for backwash and flux recovery, and water purification.

One particular type of filter configuration includes tubular system dead-end filtration. Another particular type of filter configuration includes planar cross flow filtration system. Other configurations may also be employed. Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic diagram of one embodiment of a tubular electrochemically reactive membrane system; and

FIG. 2 is a schematic diagram of one embodiment of a planar electrochemically reactive membrane filtration system.

### DETAILED DESCRIPTION

Exemplary electrochemically reactive membrane filtration systems are disclosed below. The systems include subsystems and components to measure and control process variables, such as permeate flux and pressure, for effective performance. The apparatus could employ sensors or other condition detection and control subsystems or components that might be required to process at a particular rate or at a particular scale.

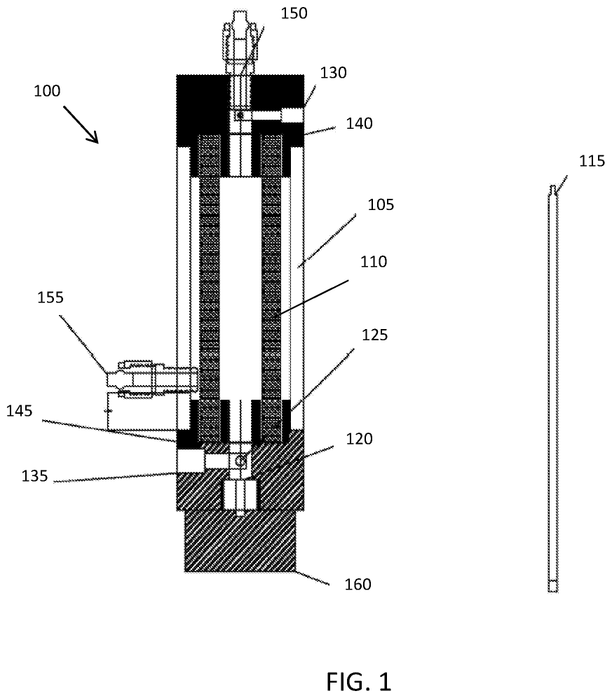

FIG. 1 is a schematic diagram of one embodiment of a tubular electrochemically reactive membrane filtration system 100. The tubular electrochemically reactive membrane filtration system 100 has a chamber case 105 and includes an electrochemically reactive membrane filter 110 and a rod 115 that is housed inside of the electrochemically reactive membrane filter 110. In one embodiment, the chamber case 105 is constructed of a non-toxic, mechanically stable, durable, and chemically resistant material, such as plexiglass or polymeric materials such as Polyvinyl chloride (PVC), Polytetrafluoroethylene (PTFE) or Polyvinylidene fluoride (PVDF).

The rod 115 serves as a counter or auxiliary electrode. It should be understood that other counter or auxiliary electrodes could be used. In one embodiment, the rod 115 is cylinder-shaped with a diameter of 3 mm and made of stainless steel and fixed at a bottom latch 120 by a holder 125. The holder 125 includes an aperture for holding the rod 115 in place and preventing movement or displacement. In one embodiment, the holder is constructed of stainless steel. However, other electrically conductive materials may be employed.

In alternative embodiments, the rod could have other shapes and dimensions and could be made of any other suitable material. For example, the rod may be constructed of any anti-corrosive conductive materials (e.g., stainless steel, copper, platinum).

A DC power source is wired to the electrochemically reactive membrane filter 110 and the stainless-steel rod 115 to provide electricity. The electrochemically reactive membrane filter 110 thus acts as both a filter and an electrode. Exemplary DC power sources include, without limitation, DC generators and AA or AAA batteries with output voltage of 3 V or higher and the total dischargeable energy of 2000 or more milli-Amp hours (mAh).

At least two chemical mechanisms are involved on the electrochemically reactive membrane filter 110, namely, (1) direct anodic oxidation, where water pollutants are oxidized after adsorption on the electrochemically reactive membrane surface, and (2) indirect electrolysis, in which organic pollutant oxidation is mediated by the reactive radicals generated on the electrochemically reactive membrane surface. For the second mechanism, radicals such as hydroxyl radicals could be formed via water oxidation at an anode surface when the electric potential is supplied. During this indirect oxidation, the agents produced on the anode, which are responsible for oxidation of inorganic and organic matters, may be chlorine and hypochlorite, hydrogen peroxide, and ozone. Moreover, during electrolysis, two species of active oxygen can be electrochemically produced on the electrochemically reactive membrane. One is the chemisorbed “active oxygen” (oxygen in the oxide lattice), while the other is the physisorbed “active oxygen” (adsorbed hydroxyl radicals).

One pair of top side connector 130 and a bottom side connector 135 provides an electrical path for the positive of DC power source to the electrochemically reactive membrane filter 110 through the tubular electrochemically reactive membrane filtration system 100. Another pair of top side connector 140 and bottom side connector 145 provides an electrical path for the negative of DC power source to the stainless-steel rod 115 through the tubular electrochemically reactive membrane filtration system 100.

In one embodiment, the electrochemically reactive membrane filter 110 is a 10-cm long one-channel tubular electrode made of porous electrode materials as mentioned above with the outer and inner diameters of 10 mm and 6 mm. It should be understood that the use of such configurations of the electrochemically reactive membrane electrode is merely exemplary, and that other titanium suboxide or any other suitable material with suitable geometry or physical configurations may also be applicable.

A top inlet conduit 150 of the system is configured to be attached to a residential tap water faucet by screw thread. Raw water flows into the electrochemically reactive membrane filter 110 under a mild hydraulic pressure provided from a peristaltic pump or from the tap water pressure itself. Outlet conduit 155 is connected to the side of the tubular electrochemically reactive membrane filtration system 100 for permeate withdraw. A bottom cap 160 of the electrochemically reactive membrane system is removable. In filtration mode, the bottom cap 160 is sealed to allow water to pass through the membrane surface only. In flush mode the bottom cap 160 is removed to allow water to flush out the fouling on the inner side of electrochemically reactive membrane filters 110.

To mitigate surface fouling and extend the effective filtration period, a DC power supply could be used to generate surface radicals and oxidative chemicals that are antimicrobial and helpful for membrane surface cleaning or defouling. For example, under DC polarization from 50 A·m⁻² to 250 A·m⁻² or approximately 10 to 22 V of cell voltage, 0.0045 mM to 0.022 mM chlorine may be generated on the cathode surface within two hours in the presence of Meanwhile, 8 μM to 55 μM H₂O₂ can also be generated on the anode surface under the same condition.

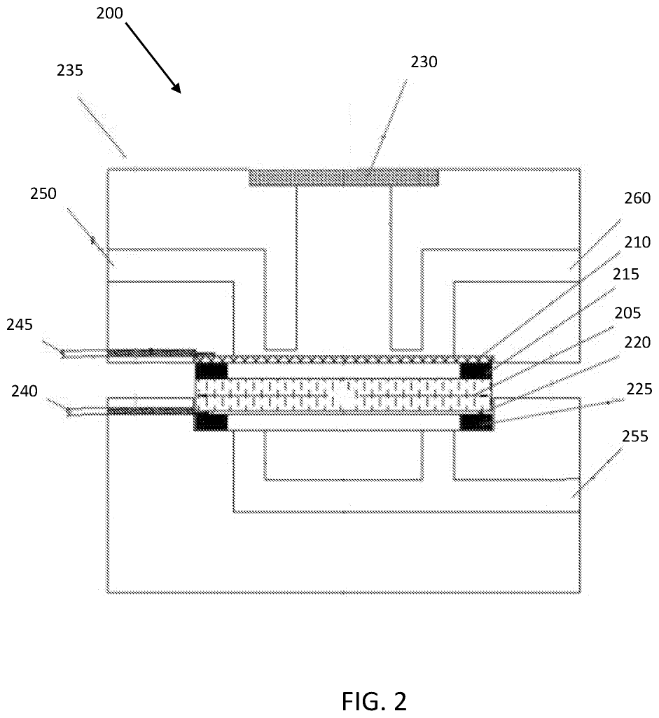

FIG. 2 is a schematic diagram of one embodiment of a planar electrochemically reactive membrane filtration system 200. The filtration system 200 includes a planar electrochemically reactive membrane filter 205, a mesh 210 disposed on top of the planar electrochemically reactive membrane filter 205. The electrochemically reactive membrane filter 205 is substantially the same as the electrochemically reactive membrane filter 110 described above with respect to FIG. 1, except for the differences discussed below.

A first O-ring 215 is disposed between the planar electrochemically reactive membrane filter 205 and the mesh 210. The first O-ring 215 may be constructed of insulation and water stopping material. A second O-ring 220 is disposed beneath and attached with the planar electrochemically reactive membrane filter 205. The second O-ring 220 may be constructed of stainless-steel or another metal. A third O-ring 225 is fixed under the second O-ring 220 to support the planar electrochemically reactive membrane filter 205. The third O-ring 225 may be constructed of insulation and water stopping material. In alternative embodiments, any number of O-rings, gaskets, or other sealing devices may be employed.

A cover 230 is capped on top of the planar electrochemically reactive membrane filtration system 200. The cover 230 may be constructed of a transparent material, such as glass or a polymeric material, for observation.

The planar electrochemically reactive membrane filtration system 200 is closed with several fasteners, such as bolts 235. When the system 200 is closed, the O-rings 215, 220, 225 seal the planar electrochemically reactive membrane filter 205. Other exemplary fasteners include, without limitation, screws, rivets, and adhesive. Alternatively, the planar electrochemically reactive membrane filtration system 200 may be closed by welding or braising.

The mesh 210 serves as a counter or auxiliary electrode. It should be understood that other counter or auxiliary electrodes could be used. In one embodiment, the mesh 210 is round-shaped and made of stainless steel. It will be understood that the mesh could have other shapes and could be made of any other suitable material. For example, the mesh may be constructed of any anti-corrosive conductive materials (e.g., stainless steel, copper, and platinum).

In one embodiment, the planar electrochemically reactive membrane filter 205 is a 47-mm diameter electrode made of Ti₄O₇. While the use of Ti₄O₇ is exemplary, the electrochemically reactive membrane could be made of any other titanium suboxide or any other suitable material displaying high conductivity and electrochemical activity. The length, inner diameter, and outer diameter of the electrode could vary.

The second O-ring 220 serves as conductive material connecting between the planar electrochemically reactive membrane filter 205 with DC power. It should be understood that other conductive material could be used.

A direct current (DC) power source, such as DC generator or batteries, is wired to the electrochemically reactive membrane and the stainless-steel mesh 210. The planar electrochemically reactive membrane filter 205 thus acts as both a filter and an electrode. At least two chemical mechanisms are involved on the planar electrochemically reactive membrane filter 205, namely, (1) direct anodic oxidation, where water pollutants are oxidized after adsorption on the electrochemically reactive membrane surface, and (2) indirect electrolysis, in which organic pollutant oxidation is mediated by the current-generated reactive radical species.

A side connector 240 provides an electrical path for the positive of DC power source to the planar electrochemically reactive membrane filter 205 through the planar electrochemically reactive membrane filtration system 200. Another side connector 245 provides an electrical path for the negative of DC power source to the stainless steel mesh 210 through the planar electrochemically reactive membrane filtration system 200.

Raw water flows into the planar electrochemically reactive membrane filter 205 under a mild hydraulic pressure provided from a peristaltic pump or from the tap water pressure itself through an inlet conduit 250. The permeate flows through the planar electrochemically reactive membrane filter 205 and flows out from permeate outlet conduit 255. The concentrated raw water flows out through discharge outlet conduit 260 to be recirculated or discharged.

In the illustrated embodiments, each of the filtration systems 100, 200 include a single electrochemically reactive membrane filter and do not include any filters other than the electrochemically reactive membrane filter. Testing has shown that a single electrochemically reactive membrane filter connected to a DC power source is sufficient to remove multiple pollutants (e.g., bacteria, dye, and chemical additives) from drinking water, without removing desirable trace metal elements. In alternative embodiments, multiple electrochemically reactive membrane filters may be employed. In still other embodiments, additional filters may be employed, such as those discussed above.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A membrane filtration system for filtering a liquid to be filtered comprising:
a cell;
an inlet conduit that provides a liquid path into the cell;
an outlet conduit for removing liquid concentrate from the cell;
a permeate outlet conduit;
a membrane cell having a filtration membrane which filters the liquid to be filtered, wherein the inlet and outlet conduits communicate with a first surface of the filtration membrane and the permeate outlet conduit communicates with a second surface of the filtration membrane, and a direct current generator producing electric field in direct contact with the liquid to be filtered and the filtration membrane.

2. The membrane filtration system as recited in claim 1 wherein the filtration membrane comprises material selected from the group consisting of ceramic, polymeric, metallic, and combinations thereof.

3. The membrane filtration system as recited by claim 1 wherein the filtration membrane is a porous filtration membrane that are functionalized membranes.

4. The membrane filtration system as recited by claim 1, further comprising a counter electrode, wherein the counter electrode is a rod or mesh that is constructed of anti-corrosive conductive materials.

5. The membrane filtration system as recited by claim 1 wherein the inlet and outlet conduits open on opposite sides of the membrane filtration system.

6. The membrane filtration system as recited by claim 1 wherein the inlet conduit is configured to be connected to a residential tap water faucet.

7. The membrane filtration system as recited in claim 1 wherein the filtration membrane is connected with a direct current power source and wherein the membrane cell and the direct current power source is fixed or movable.

8. The membrane filtration system as recited by claim 1 wherein the inlet and outlet conduits, the filtration membrane, and the permeate outlet conduit provides a dead-end or cross-flow filtration system.

9. The membrane filtration as recited by claim 1, configured as a closed housing structure comprising a main housing which completely encloses the membrane cell, and wherein the main housing defines the inlet conduit, the outlet conduit, and the permeate outlet conduit.

10. A method of filtering a liquid, the method comprising:
receiving a liquid in an inlet conduit of a cell;
filtering the liquid received in the inlet conduit with an electrochemically reactive membrane surface, wherein the filtering includes:
oxidizing water pollutants after adsorption on the electrochemically reactive membrane surface, and
mediating organic pollutant oxidation by reactive radicals generated on the electrochemically reactive membrane surface;
passing the liquid from the electrochemically reactive membrane surface to an outlet conduit; and
removing liquid concentrate at the outlet conduit.

11. The method of claim 10, further comprising attaching the inlet conduit to a residential tap water faucet.

12. The method of claim 10, further comprising applying a current to the electrochemically reactive membrane surface.

13. The method of claim 10, further comprising flushing the cell.

14. An electrochemically reactive membrane filtration system comprising:
a chamber case;
an electrochemically reactive membrane filter;
a rod housed inside of the electrochemically reactive membrane filter;
a DC power source electrically connected to the electrochemically reactive membrane filter;
a top inlet conduit; and
an outlet conduit.

15. The system of claim 14, further comprising a bottom cap.

16. The system of claim 14, wherein the DC power source is a battery.

17. The system of claim 14, further comprising a first pair of top side connectors connected to the electrochemically reactive membrane filter and a first bottom side connector connected to the electrochemically reactive membrane filter.

18. The system of claim 17, wherein the first pair of top side connectors and the first bottom side connector provides an electrical path for a positive of the DC power source to the electrochemically reactive membrane filter.

19. The system of claim 18, further comprising a second pair of top side connectors connected to the rod and a second bottom side connector connected to rod.

20. The system of claim 19, wherein the second pair of top side connectors and the second bottom side connector provides an electrical path for a negative of DC power source to the stainless-steel rod
